(19) United States
(12) Patent Application Publication
(10) Pub. No.: US 2025/0162043 A1
(43) Pub. Date: May 22, 2025

(54) PRECISE MANUFACTURING METHOD FOR MANUFACTURING A LIQUID CONTAINER

(71) Applicant: CHENG UEI PRECISION INDUSTRY CO., LTD., New Taipei City (TW)

(72) Inventors: ZAN-GUO ZHOU, Dong-Guan City, Guangdong Province (CN); MING-CHENG ZI, Dong-Guan City, Guangdong Province (CN)

(21) Appl. No.: 18/760,012

(22) Filed: Jun. 30, 2024

(30) Foreign Application Priority Data
Nov. 17, 2023 (CN) 202311540748.6

(51) Int. Cl. B23B 47/28

(52) U.S. Cl. CPC B23B 47/28; B23B 2247/04; B23B 2247/12

(57) ABSTRACT

A precise manufacturing method for manufacturing a liquid container is described hereinafter. Assemble a first jig element with a second jig element. Make a first datum plane at the first jig element, and make a second datum plane at the second jig element, next, unlock the first jig element and the second jig element. Assemble a base with the first jig element, assemble a cup-shaped element with the second jig element. Make a through hole at the cup-shaped element, and the through hole is corresponding to the second datum plane, make an assembling portion at the base, and the assembling portion together with a perforation is corresponding to the first datum plane. Detach the second jig element, detach the first jig element, and then the cup-shaped element is assembled with the base, so the perforation and the through hole are located at the same direction.

### CROSS-REFERENCE TO RELATED APPLICATION

The present application is based on, and claims priority from, China Patent Application No. 202311540748.6, filed Nov. 17, 2023, the disclosure of which is hereby incorporated by reference herein in its entirety.

### BACKGROUND OF THE INVENTION

### Field of the Invention

The present invention generally relates to a manufacturing method, and more particularly to a precise manufacturing method for manufacturing a liquid container to make the liquid container have a better position aligning effect.

### Description of the Prior Art

In a conventional manufacturing method, a plurality of parts are combined to form a component, or a plurality of the components are combined to form a product.

Referring to FIG. 11, a conventional liquid container of an electronic atomizer includes a cup-shaped element 3′ and a base 4′. The conventional liquid container may contain oil substances. The cup-shaped element 3′ is assembled with the base 4′ by a screw and a thread hole. A position of a through hole 32′ of the cup-shaped element 3′ needs being corresponding to a position of an assembling portion 42′ of the base 4′ to ensure an assembling accuracy of the conventional liquid container.

However, in the conventional manufacturing process, when a tooth tapping machine and a tooth turning machine are used, an original tooth position is without being positioned, so when the cup-shaped element 3′ is assembled with the base 4′, relative positions of the through hole 32′ and assembling portion 42′ generate a randomness. As a result, a yield rate of the conventional liquid container is affected.

Thus, it is essential to provide a precise manufacturing method for manufacturing a liquid container to make the liquid container have a better position aligning effect.

### BRIEF SUMMARY OF THE INVENTION

An object of the present invention is to provide a precise manufacturing method for manufacturing a liquid container to make the liquid container have a better position aligning effect. The liquid container includes a cup-shaped element and a base. The precise manufacturing method for manufacturing the liquid container is described hereinafter. Assemble a first thread column of a first jig element with a first thread hole of a second jig element, and then the first jig element is locked with the second jig element by locking the first thread column and the first thread hole. Make a first datum plane at one side of a peripheral surface of the first jig element, and make a second datum plane at one side of a peripheral surface of the second jig element, next, unlock the first jig element and the second jig element. Assemble the base with the first jig element, and the first thread column of the first jig element is locked to a second thread hole of the base, assemble the cup-shaped element with the second jig element, and a second thread column of the cup-shaped element is locked to the first thread hole of the second jig element. Make a through hole formed at one side of a peripheral wall of the cup-shaped element by the second datum plane of the second jig element, and the through hole is corresponding to a middle of the second datum plane of the second jig element, make an assembling portion formed at one side of a peripheral surface of the base by the first datum plane of the first jig element, a perforation is formed in a middle of the assembling portion, and the assembling portion together with the perforation is corresponding to a middle of the first datum plane of the first jig element. Detach the second jig element from the cup-shaped element, detach the first jig element from the base, and then the cup-shaped element is assembled with the base, the second thread column of the cup-shaped element is locked to the second thread hole of the base, so the perforation of the assembling portion and the through hole of the liquid container are located at the same direction.

Another object of the present invention is to provide a precise manufacturing method for manufacturing a liquid container. The liquid container includes a cup-shaped element and a base. The precise manufacturing method for manufacturing the liquid container is described hereinafter. Assemble a first thread column of a first jig element with a first thread hole of a second jig element, and then the first jig element is locked with the second jig element by locking the first thread column and the first thread hole. Make a first datum plane at one side of a peripheral surface of the first jig element, and make a second datum plane at one side of a peripheral surface of the second jig element, the first datum plane is in alignment with the second datum plane, the first datum plane is flush with the second datum plane, next, unlock the first jig element and the second jig element. Assemble the base with the first jig element, and the first thread column of the first jig element is locked to a second thread hole of the base, assemble the cup-shaped element with the second jig element, and a second thread column of the cup-shaped element is locked to the first thread hole of the second jig element. Make a through hole formed at one side of a peripheral wall of the cup-shaped element by the second datum plane of the second jig element, and the through hole is corresponding to a middle of the second datum plane of the second jig element, make an assembling portion formed at one side of a peripheral surface of the base by the first datum plane of the first jig element, a perforation is formed in a middle of the assembling portion, and the assembling portion together with the perforation is corresponding to a middle of the first datum plane of the first jig element. Detach the second jig element from the cup-shaped element, detach the first jig element from the base, and then the cup-shaped element is assembled with the base, the second thread column of the cup-shaped element is locked to the second thread hole of the base, so the perforation of the assembling portion and the through hole of the liquid container are located at the same direction.

Another object of the present invention is to provide a precise manufacturing method for manufacturing a liquid container. The liquid container includes a cup-shaped element and a base. The precise manufacturing method for manufacturing the liquid container is described hereinafter. Assemble a first thread column of a first jig element with a first thread hole of a second jig element, and then the first jig element is locked with the second jig element by locking the first thread column and the first thread hole. Make a first datum plane at one side of a peripheral surface of the first jig element, and make a second datum plane at one side of a peripheral surface of the second jig element, the first datum plane is in alignment with the second datum plane, the first datum plane is flush with the second datum plane, next, unlock the first jig element and the second jig element. Assemble the base with the first jig element, and the first thread column of the first jig element is locked to a second thread hole of the base, assemble the cup-shaped element with the second jig element, and a second thread column of the cup-shaped element is locked to the first thread hole of the second jig element. Make a through hole formed at one side of a peripheral wall of the cup-shaped element by the second datum plane of the second jig element, and the through hole is corresponding to a middle of the second datum plane of the second jig element, make an assembling portion formed at one side of a peripheral surface of the base by the first datum plane of the first jig element, a perforation is formed in a middle of the assembling portion, and the assembling portion together with the perforation is corresponding to a middle of the first datum plane of the first jig element. Detach the second jig element from the cup-shaped element, detach the first jig element from the base, and then the cup-shaped element is assembled with the base, the second thread column of the cup-shaped element is locked to the second thread hole of the base, the through hole of the cup-shaped element is corresponding to the perforation of the assembling portion of the base.

As described above, the through hole of the cup-shaped element is corresponding to the first datum plane of the first jig element, and the perforation of the assembling portion of the base is corresponding to the second datum plane of the second jig element, so a position of the through hole of the cup-shaped element is corresponding to the perforation of the assembling portion by the precise manufacturing method for manufacturing the liquid container using the precise manufacturing jig for manufacturing the liquid container. Furthermore, when the cup-shaped element is assembled with the base, the through hole and the perforation of the assembling portion of the base are located at the same direction. As a result, the precise manufacturing method for manufacturing the liquid container makes the liquid container have a better position aligning effect.

### BRIEF DESCRIPTION OF THE DRAWINGS

The present invention will be apparent to those skilled in the art by reading the following description, with reference to the attached drawings, in which:

FIG. 1 is a flow chart showing specific steps of a precise manufacturing method for manufacturing a liquid container according to the present invention;

FIG. 2 is a flow chart showing a manufacturing process of a precise manufacturing jig for manufacturing the liquid container in accordance with the present invention;

FIG. 3 is a perspective view of a first jig element and a second jig element of the precise manufacturing jig for manufacturing the liquid container in accordance with the present invention;

FIG. 4 is a perspective view of the first jig element in accordance with the present invention;

FIG. 5 is a perspective view of the second jig element in accordance with the present invention;

FIG. 6 is an assembling view of the first jig element and a base in accordance with the present invention;

FIG. 7 is an assembling view of the second jig element and a cup-shaped element in accordance with the present invention;

FIG. 8 is an assembling view of the base and the cup-shaped element in accordance with the present invention;

FIG. 9 is an exploded view of the base and the cup-shaped element in accordance with the present invention;

FIG. 10 is a perspective view of the first jig element and the second jig element in accordance with the present invention; and

FIG. 11 is a perspective view of a conventional liquid container in prior art.

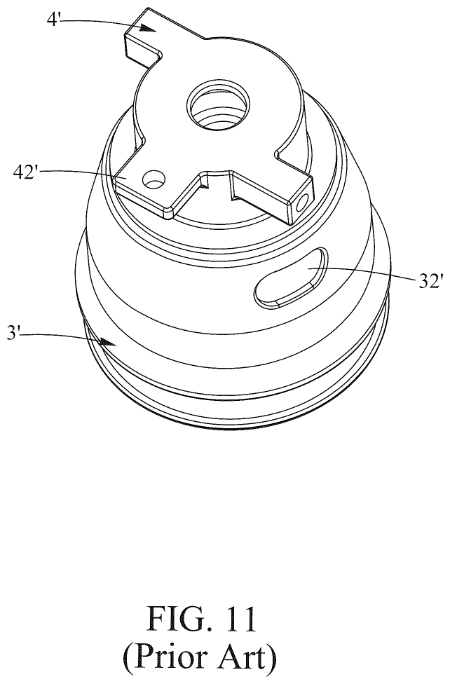

### DETAILED DESCRIPTION OF THE INVENTION

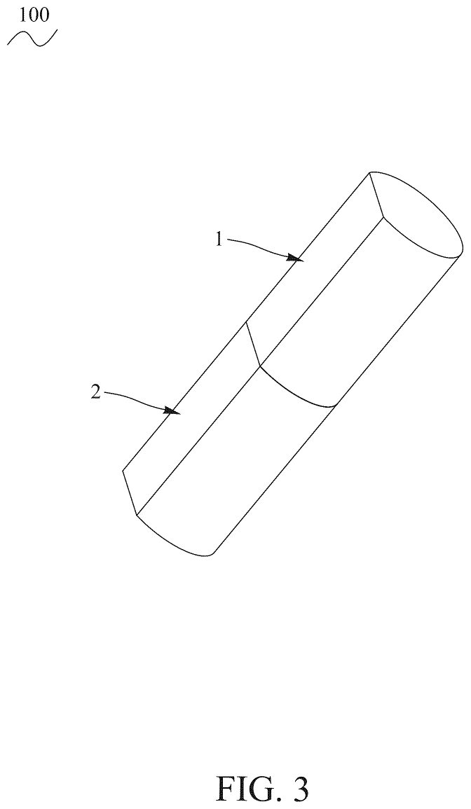

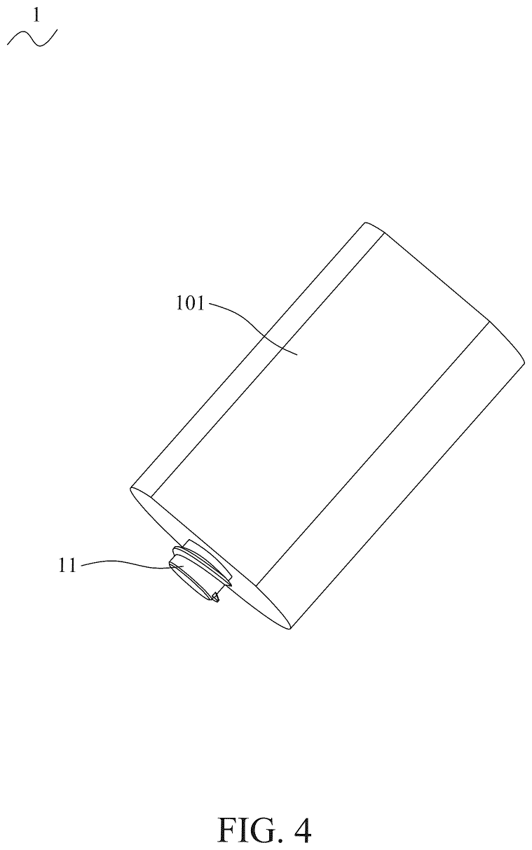

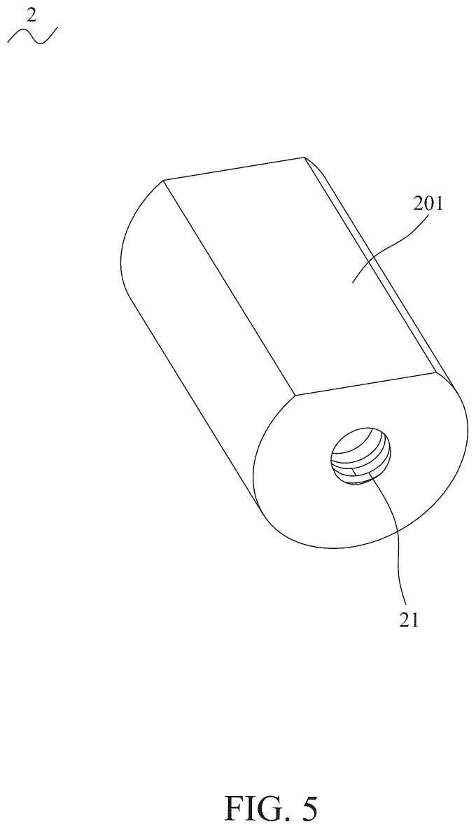

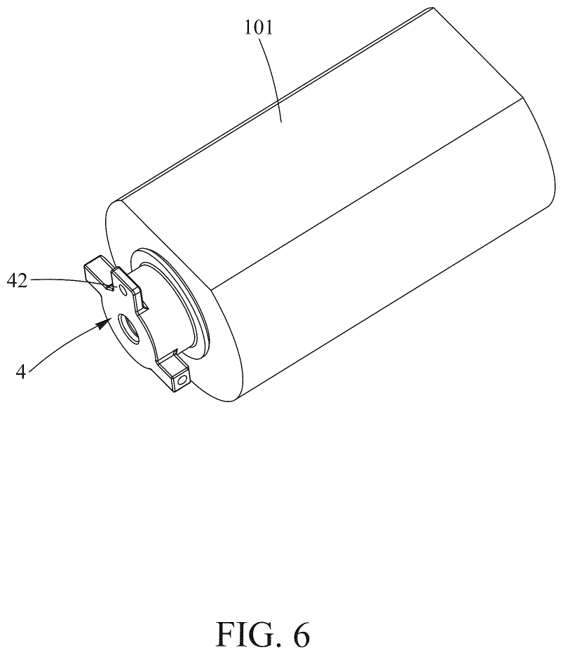

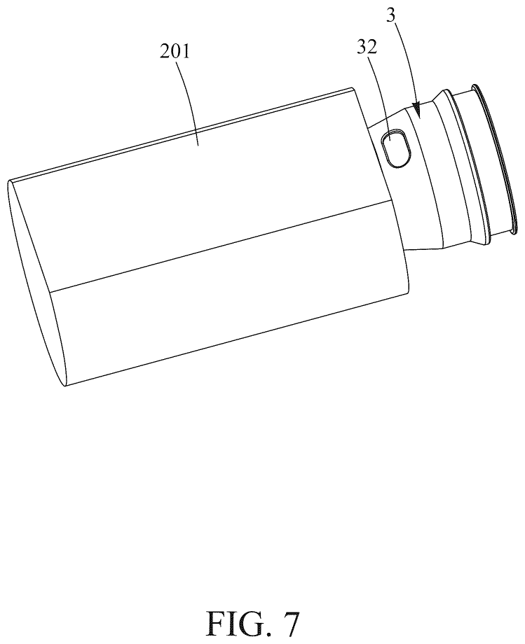

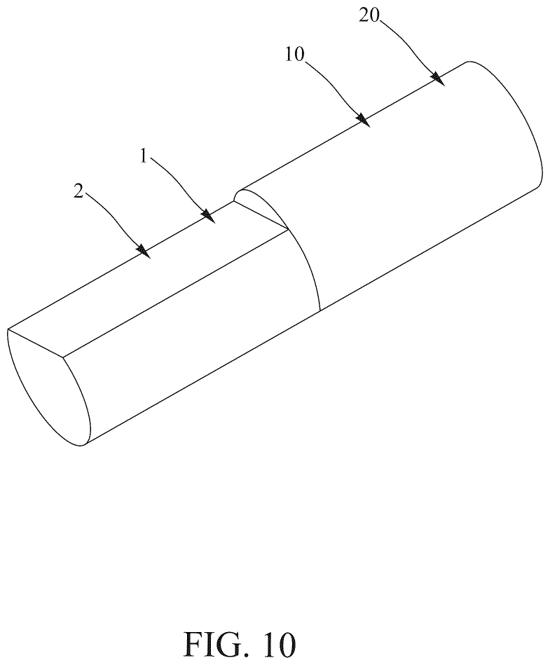

With reference to FIG. 3 to FIG. 10, a precise manufacturing method for manufacturing a liquid container 200 according to the present invention is shown. The liquid container 200 includes a cup-shaped element 3 and a base 4. The precise manufacturing method for manufacturing the liquid container 200 applies a precise manufacturing jig 100 for manufacturing the liquid container 200 to manufacture the liquid container 200 so as to ensure that a perforation 421 of an assembling portion 42 of the base 4 and a through hole 32 of the cup-shaped element 3 are located at the same direction. The precise manufacturing jig 100 for manufacturing the liquid container 200 includes a first jig element 1 and a second jig element 2. The cup-shaped element 3 is assembled with the base 4 by the first jig element 1 and the second jig element 2.

The precise manufacturing method for manufacturing the liquid container 200 is executed by a cooperation of the first jig element 1 and the base 4 and a cooperation of the second jig element 2 and the cup-shaped element 3. A middle of an outer surface of one end of the first jig element 1 extends outward to form a first thread column 11. A middle of an outer surface of one end of the second jig element 2 is recessed inward to form a first thread hole 21. A middle of an outer surface of one end of the cup-shaped element 3 extends outward to form a second thread column 31. An inside of the cup-shaped element 3 has a holding space 301 penetrating through an outer surface of the other end of the cup-shaped element 3. A middle of an outer surface of one end of the base 4 is recessed inward to form a second thread hole 41 penetrating through a middle of an outer surface of the other end of the base 4. The cup-shaped element 3 is assembled by the second jig element 2. The base 4 is assembled by the first jig element 1.

The first thread column 11 of the first jig element 1 is matched with the first thread hole 21 of the second jig element 2. The second thread column 31 of the cup-shaped element 3 is matched with the second thread hole 41 of the base 4. The first thread column 11 of the first jig element 1 is matched with the second thread hole 41 of the base 4. The first thread hole 21 of the second jig element 2 is matched with the second thread column 31 of the cup-shaped element 3.

In the present invention, a thread diameter of the first thread column 11 of the first jig element 1, a thread diameter of the first thread hole 21 of the second jig element 2, a thread diameter of the second thread column 31 of the cup-shaped element 3 and a thread diameter of the second thread hole 41 of the base 4 are the same. A thread pitch of the first thread column 11 of the first jig element 1, a thread pitch of the first thread hole 21 of the second jig element 2, a thread pitch of the second thread column 31 of the cup-shaped element 3 and a thread pitch of the second thread hole 41 of the base 4 are the same. A thread length of the first thread column 11 of the first jig element 1, a thread length of the first thread hole 21 of the second jig element 2, a thread length of the second thread column 31 of the cup-shaped element 3 and a thread length of the second thread hole 41 of the base 4 are the same.

The first jig element 1 is a cylinder shape, and the second jig element 2 is the cylinder shape. One side of a peripheral surface of the first jig element I defines a first datum plane 101. One side of a peripheral surface of the second jig element 2 defines a second datum plane 201. The first datum plane 101 and the second datum plane 201 are the same. A width of the first datum plane 101 is the same as a width of the second datum plane 201. The first thread column 11 of the first jig element I is screwed in the second thread hole 41 of the base 4, and the second thread column 31 of the cup-shaped element 3 is screwed in the first thread hole 21 of the second jig clement 2. When the first thread column 11 of the first jig element 1 is assembled with the first thread hole 21 of the second jig element 2, the first datum plane 101 is in alignment with the second datum plane 201, the first datum plane 101 is flush with the second datum plane 201.

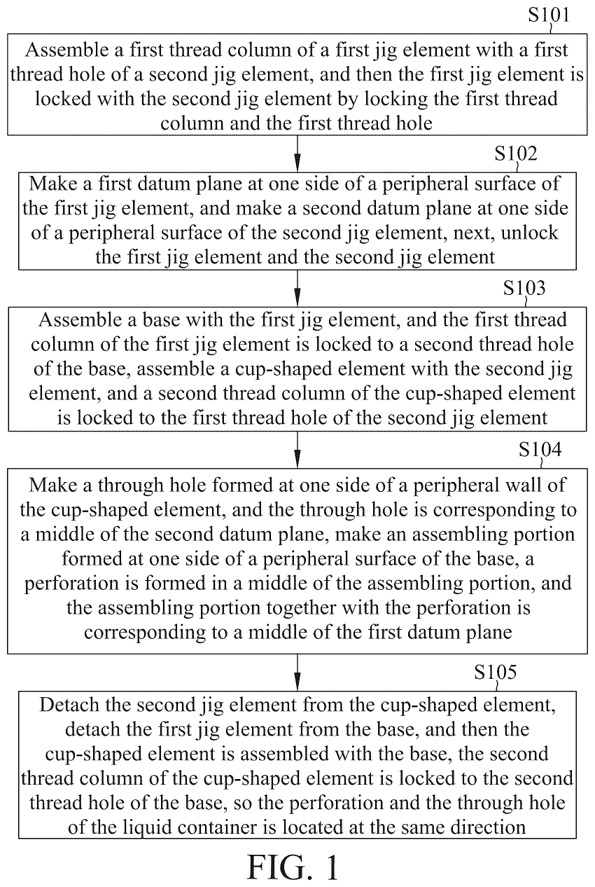

Referring to FIG. 1 to FIG. 10, a flow chart of the precise manufacturing method for manufacturing the liquid container 200 is shown in FIG. 1. The cup-shaped element 3 and the base 4 of the liquid container 200 are assembled by the precise manufacturing method for manufacturing the liquid container 200. The precise manufacturing jig 100 for manufacturing the liquid container 200 is applied in the precise manufacturing method for manufacturing the liquid container 200. Specific steps of the precise manufacturing method for manufacturing the liquid container 200 are described as follows.

Step S101: assemble the first thread column 11 of the first jig element 1 with the first thread hole 21 of the second jig element 2, and then the first jig element 1 is locked with the second jig clement 2 by locking the first thread column 11 and the first thread hole 21.

Step S102: make the first datum plane 101 at the one side of the peripheral surface of the first jig element 1, and make the second datum plane 201 at the one side of the peripheral surface of the second jig element 2. Next, unlock the first jig element I and the second jig element 2.

Step S103: assemble the base 4 with the first jig element 1, and the first thread column 11 of the first jig element 1 is locked to the second thread hole 41 of the base 4, assemble the cup-shaped clement 3 with the second jig element 2, and the second thread column 31 of the cup-shaped element 3 is locked to the first thread hole 21 of the second jig element 2.

Step S104: make the through hole 32 formed at one side of a peripheral wall of the cup-shaped clement 3 by the second datum plane 201 of the second jig element 2, and the through hole 32 is corresponding to a middle of the second datum plane 201 of the second jig clement 2. Make the assembling portion 42 formed at one side of a peripheral surface of the base 4 by the first datum plane 101 of the first jig element 1, the perforation 421 is formed in a middle of the assembling portion 42, and the assembling portion 42 together with the perforation 421 is corresponding to a middle of the first datum plane 101 of the first jig element 1.

Step S105: detach the second jig element 2 from the cup-shaped element 3, detach the first jig element 1 from the base 4, and then the cup-shaped element 3 is assembled with the base 4. Specifically, the second thread column 31 of the cup-shaped element 3 is locked to the second thread hole 41 of the base 4, so the perforation of the assembling portion 42 and the through hole 32 of the liquid container 200 are located at the same direction.

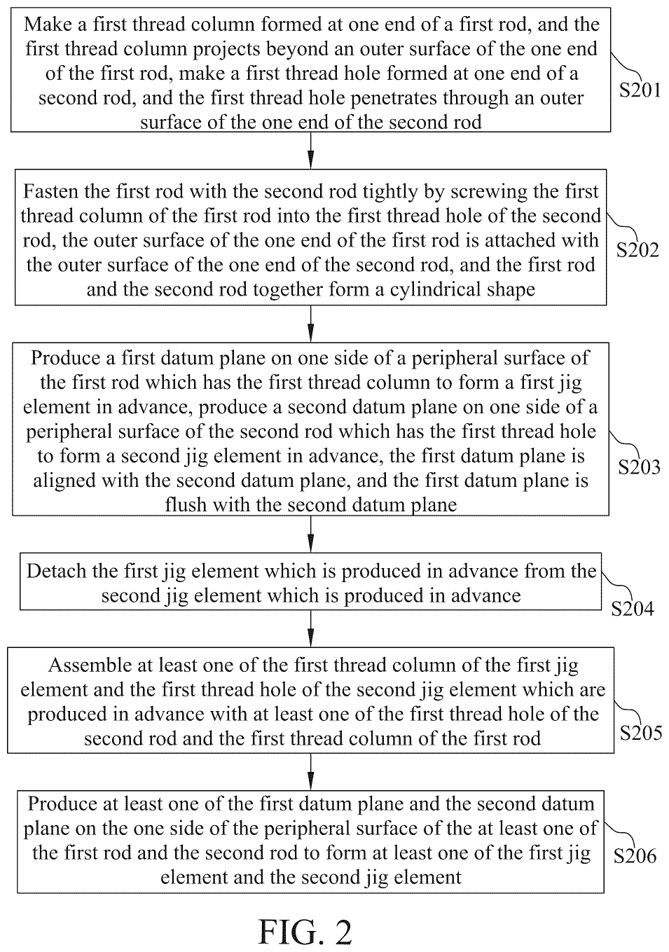

Referring to FIG. 1 to FIG. 10, the first Step S101 and the second Step S102 further include following steps. A flow chart showing a manufacturing process of the precise manufacturing jig 100 for manufacturing the liquid container 200 is shown in FIG. 2. In the present invention, the first jig element 1 is formed by a first rod 10. The second jig element 2 is formed by a second rod 20.

Step S201: make the first thread column 11 formed at one end of the first rod 10, and the first thread column 11 projects beyond an outer surface of the one end of the first rod 10, make the first thread hole 21 formed at one end of the second rod 20, and the first thread hole 21 penetrates through an outer surface of the one end of the second rod 20.

Step S202: fasten the first rod 10 with the second rod 20 tightly by screwing the first thread column 11 of the first rod 10 into the first thread hole 21 of the second rod 20, the outer surface of the one end of the first rod 10 is matched with the outer surface of the one end of the second rod 20, the outer surface of the one end of the first rod 10 is attached with the outer surface of the one end of the second rod 20, and the first rod 10 and the second rod 20 together form a cylindrical shape.

Step S203: produce the first datum plane 101 on one side of a peripheral surface of the first rod 10 which has the first thread column 11 to form the first jig element 1 in advance, produce the second datum plane 201 on one side of a peripheral surface of the second rod 20 which has the first thread hole 21 to form the second jig element 2 in advance, the first datum plane 101 and the second datum plane 201 are on the same level, the first datum plane 101 is aligned with the second datum plane 201, and the first datum plane 101 is flush with the second datum plane 201. The peripheral surface of the first rod 10 is in alignment with the peripheral surface of the second rod 20.

Step S204: detach the first jig element 1 which is produced in advance from the second jig element 2 which is produced in advance.

Step S205: assemble at least one of the first thread column 11 of the first jig element 1 and the first thread hole 21 of the second jig element 2 which are produced in advance with at least one of the first thread hole 21 of the second rod 20 and the first thread column 11 of the first rod 10.

Step S206: produce at least one of the first datum plane 101 and the second datum plane 201 on the one side of the peripheral surface of the at least one of the first rod 10 and the second rod 20 to form at least one of the first jig element 1 and the second jig element 2, and the at least one of the first datum plane 101 and the second datum plane 201 on the one side of the peripheral surface of the at least one of the first rod 10 and the second rod 20 are coplanar with at least one of the first datum plane 101 of the first jig element 1 and the second datum plane 201 of the second jig element 2 which are produced in advance.

Repeat the aforesaid steps which are from the Step S201 to the Step S206 to continuously manufacture a plurality of the first jig elements 1 and a plurality of the second jig elements 2 by use of the precise manufacturing jig 100 for manufacturing the liquid container 200 and the precise manufacturing method for manufacturing the liquid container 200. When the precise manufacturing jig 100 for manufacturing the liquid container 200 is damaged, the first jig element 1 and the second jig element 2 of the precise manufacturing jig 100 for manufacturing the liquid container 200 are able to be replaced. When the liquid container 200 is manufactured in mass, the first jig clement 1 and the second jig element 2 ensure a consistency. The first rod 10 and the second rod 20 are stainless rods.

A position of the through hole 32 of the cup-shaped element 3 is corresponding to the middle of the second datum plane 201 of the second jig element 2. A position of the perforation 421 of the assembling portion 42 of the base 4 is corresponding to the middle of the first datum plane 101 of the first jig element 1. After the cup-shaped element 3 is locked to the base 4, the through hole 32 of the cup-shaped clement 3 is corresponding to the perforation 421 of the assembling portion 42 of the base 4, so an assembling accuracy between the cup-shaped element 3 and the base 4 is improved, and a convenience is provided for an air flow.

In a concrete implementation, a shape of the through hole 32 of the cup-shaped element 3 and a shape of the perforation 421 of the assembling portion 42 of the base 4 are without being limited. The shape of the through hole 32 of the cup-shaped element 3 and the shape of the perforation 421 of the assembling portion 42 of the base 4 are able to be changed, the through hole 32 of the cup-shaped element 3 and the perforation 421 of the assembling portion 42 of the base 4 are able to be replaced by any structures with any shapes which ensure a direction consistency in a thread connection.

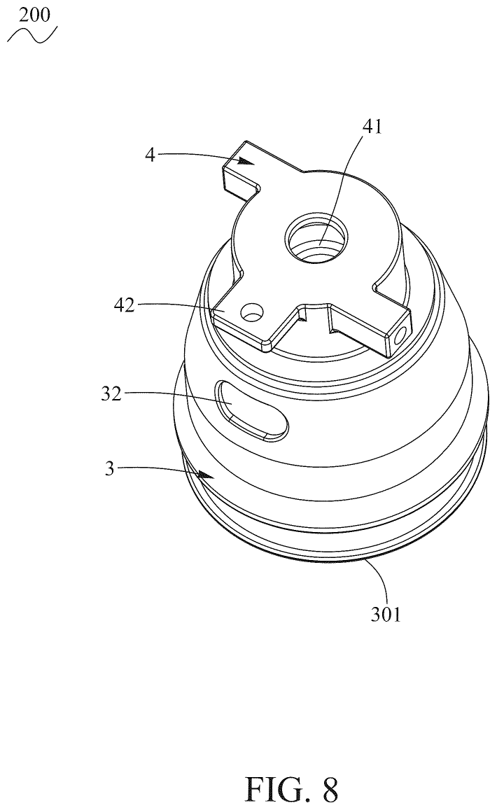

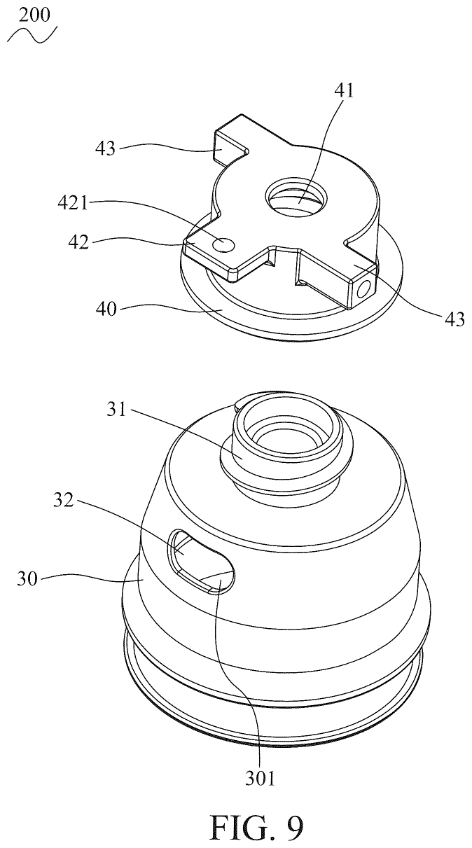

Referring to FIG. 8 and FIG. 9, the base 4 is disposed to a top of the cup-shaped element 3. The one side of the peripheral wall of the cup-shaped element 3 has the through hole 32 penetrating through the peripheral wall of the cup-shaped element 3. The cup-shaped element 3 has a first main portion 30, the second thread column 31 and the through hole 32. A middle of a top surface of the first main portion 30 extends upward to form the second thread column 31. The through hole 32 penetrates through an inner surface and an outer surface of the first main portion 30.

The base 4 has a second main portion 40, the second thread hole 41, the assembling portion 42 and two locking portions 43. The one side of the peripheral surface of the base 4 protrudes outward to form the assembling portion 42. The middle of the assembling portion 42 defines the perforation 421 vertically penetrating through the assembling portion 42. A middle of a bottom surface of the second main portion 40 is recessed inward to form the second thread hole 41 penetrating through a middle of a top surface of the second main portion 40. One side of an upper portion of a peripheral surface of the second main portion 40 extends outward to form the assembling portion 42. A top surface of the assembling portion 42 is flush with the top surface of the second main portion 40. Two areas of the upper portion of the peripheral surface of the second main portion 40 extend outward to form the two locking portions 43. The two locking portions 43 are disposed to two opposite sides of the assembling portion 42, respectively. The assembling portion 42 is located between the two locking portions 43. The two locking portions 43 are used for locking the base 4. The two locking portions 43 make the base 4 easily locked to the cup-shaped element 3. The first datum plane 101 of the first jig element 1 and the second datum plane 201 of the second jig element 2 are ensured to be consistent, other datum planes are able to be produced to manufacture the two locking portions 43 of other parts of the base 4.

In use, an electronic atomizer (not shown) includes the liquid container 200. Preferably, the electronic atomizer has a filtering function. The liquid container 200 contains using substances which are used by the electronic atomizer. The using substances are able to be oil substances. The electronic atomizer filters fog drops or atomized grains generated by the using substances to eliminate an affection of harmful substances or potentially harmful substances of the fog drops or the atomized grains of the using substances. The electronic atomizer is also able to filter outside air. The harmful substances or potentially harmful substances of the fog drops or the atomized grains of the using substances are harmful substances or potentially harmful substances which are most easily coagulated.

As described above, the through hole 32 of the cup-shaped element 3 is corresponding to the first datum plane 101 of the first jig element 1, and the perforation 421 of the assembling portion 42 of the base 4 is corresponding to the second datum plane 201 of the second jig element 2, so the position of the through hole 32 of the cup-shaped element 3 is corresponding to the perforation 421 of the assembling portion 42 by the precise manufacturing method for manufacturing the liquid container 200 using the precise manufacturing jig 100 for manufacturing the liquid container 200. Furthermore, when the cup-shaped element 3 is assembled with the base 4. the through hole 32 and the perforation 421 of the assembling portion 42 of the base 4 are located at the same direction. As a result, the precise manufacturing method for manufacturing the liquid container 200 makes the liquid container 200 have a better position aligning effect.

What is claimed is:

1. A precise manufacturing method for manufacturing a liquid container, the liquid container including a cup-shaped element and a base, the precise manufacturing method for manufacturing the liquid container comprising steps of:
assembling a first thread column of a first jig element with a first thread hole of a second jig element, and then the first jig element being locked with the second jig element by locking the first thread column and the first thread hole;
making a first datum plane at one side of a peripheral surface of the first jig element, and making a second datum plane at one side of a peripheral surface of the second jig element, next, unlocking the first jig element and the second jig element;
assembling the base with the first jig element, and the first thread column of the first jig element being locked to a second thread hole of the base, assembling the cup-shaped element with the second jig element, and a second thread column of the cup-shaped element being locked to the first thread hole of the second jig element;
making a through hole formed at one side of a peripheral wall of the cup-shaped element by the second datum plane of the second jig element, and the through hole being corresponding to a middle of the second datum plane of the second jig element, making an assembling portion formed at one side of a peripheral surface of the base by the first datum plane of the first jig element, a perforation being formed in a middle of the assembling portion, and the assembling portion together with the perforation being corresponding to a middle of the first datum plane of the first jig element; and
detaching the second jig element from the cup-shaped element, detaching the first jig element from the base, and then the cup-shaped element being assembled with the base, the second thread column of the cup-shaped element being locked to the second thread hole of the base, so the perforation of the assembling portion and the through hole of the liquid container being located at the same direction.

2. The precise manufacturing method for manufacturing the liquid container as claimed in claim 1, wherein the step of assembling the first jig element and the second jig element and the step of making the first datum plane and the second datum plane further include following steps: make the first thread column formed at one end of a first rod, and the first thread column projects beyond an outer surface of the one end of the first rod, make the first thread hole formed at one end of a second rod, and the first thread hole penetrates through an outer surface of the one end of the second rod, fasten the first rod with the second rod tightly by screwing the first thread column of the first rod into the first thread hole of the second rod, produce the first datum plane on one side of a peripheral surface of the first rod which has the first thread column to form the first jig element in advance, produce the second datum plane on one side of a peripheral surface of the second rod which has the first thread hole to form the second jig element in advance, detach the first jig element which is produced in advance from the second jig element which is produced in advance, assemble at least one of the first thread column of the first jig element and the first thread hole of the second jig element which are produced in advance with at least one of the first thread hole of the second rod and the first thread column of the first rod, produce at least one of the first datum plane and the second datum plane on the one side of the peripheral surface of the at least one of the first rod and the second rod to form at least one of the first jig element and the second jig element, and the at least one of the first datum plane and the second datum plane on the one side of the peripheral surface of the at least one of the first rod and the second rod are coplanar with at least one of the first datum plane of the first jig element and the second datum plane of the second jig element which are produced in advance.

3. The precise manufacturing method for manufacturing the liquid container as claimed in claim 2, wherein the peripheral surface of the first rod is in alignment with the peripheral surface of the second rod.

4. The precise manufacturing method for manufacturing the liquid container as claimed in claim 2, wherein the outer surface of the one end of the first rod is matched with the outer surface of the one end of the second rod, the outer surface of the one end of the first rod is attached with the outer surface of the one end of the second rod, and the first rod and the second rod together form a cylindrical shape.

5. The precise manufacturing method for manufacturing the liquid container as claimed in claim 1, wherein the first datum plane and the second datum plane are on the same level, the first datum plane is aligned with the second datum plane, and the first datum plane is flush with the second datum plane.

6. The precise manufacturing method for manufacturing the liquid container as claimed in claim 1, wherein the first thread column of the first jig element is matched with the first thread hole of the second jig element, the second thread column of the cup-shaped element is matched with the second thread hole of the base, the first thread column of the first jig element is matched with the second thread hole of the base, the first thread hole of the second jig element is matched with the second thread column of the cup-shaped element.

7. The precise manufacturing method for manufacturing the liquid container as claimed in claim 1, wherein the first jig element is a cylinder shape, and the second jig element is the cylinder shape.

8. The precise manufacturing method for manufacturing the liquid container as claimed in claim 1, wherein the one side of the peripheral wall of the cup-shaped element has the through hole penetrating through the peripheral wall of the cup-shaped element.

9. The precise manufacturing method for manufacturing the liquid container as claimed in claim 1, wherein the middle of the assembling portion defines the perforation vertically penetrating through the assembling portion.

10. The precise manufacturing method for manufacturing the liquid container as claimed in claim 1, wherein the first thread column of the first jig element is screwed in the second thread hole of the base, and the second thread column of the cup-shaped element is screwed in the first thread hole of the second jig element.

11. A precise manufacturing method for manufacturing a liquid container, the liquid container including a cup-shaped element and a base, the precise manufacturing method for manufacturing the liquid container comprising steps of:
assembling a first thread column of a first jig element with a first thread hole of a second jig element, and then the first jig element being locked with the second jig element by locking the first thread column and the first thread hole;
making a first datum plane at one side of a peripheral surface of the first jig element, and making a second datum plane at one side of a peripheral surface of the second jig element, the first datum plane being in alignment with the second datum plane, the first datum plane being flush with the second datum plane, next, unlocking the first jig element and the second jig element;
assembling the base with the first jig element, and the first thread column of the first jig element being locked to a second thread hole of the base, assembling the cup-shaped element with the second jig element, and a second thread column of the cup-shaped element being locked to the first thread hole of the second jig element;
making a through hole formed at one side of a peripheral wall of the cup-shaped element by the second datum plane of the second jig element, and the through hole being corresponding to a middle of the second datum plane of the second jig element, making an assembling portion formed at one side of a peripheral surface of the base by the first datum plane of the first jig element, a perforation being formed in a middle of the assembling portion, and the assembling portion together with the perforation being corresponding to a middle of the first datum plane of the first jig element; and
detaching the second jig element from the cup-shaped element, detaching the first jig element from the base, and then the cup-shaped element being assembled with the base, the second thread column of the cup-shaped element being locked to the second thread hole of the base, so the perforation of the assembling portion and the through hole of the liquid container being located at the same direction.

12. A precise manufacturing method for manufacturing a liquid container, the liquid container including a cup-shaped element and a base, the precise manufacturing method for manufacturing the liquid container comprising steps of:
assembling a first thread column of a first jig element with a first thread hole of a second jig element, and then the first jig element being locked with the second jig element by locking the first thread column and the first thread hole;
making a first datum plane at one side of a peripheral surface of the first jig element, and making a second datum plane at one side of a peripheral surface of the second jig element, the first datum plane being in alignment with the second datum plane, the first datum plane being flush with the second datum plane, next, unlocking the first jig element and the second jig element;
assembling the base with the first jig element, and the first thread column of the first jig element being locked to a second thread hole of the base, assembling the cup-shaped element with the second jig element, and a second thread column of the cup-shaped element being locked to the first thread hole of the second jig element;
making a through hole formed at one side of a peripheral wall of the cup-shaped element by the second datum plane of the second jig element, and the through hole being corresponding to a middle of the second datum plane of the second jig element, making an assembling portion formed at one side of a peripheral surface of the base by the first datum plane of the first jig element, a perforation being formed in a middle of the assembling portion, and the assembling portion together with the perforation being corresponding to a middle of the first datum plane of the first jig element; and
detaching the second jig element from the cup-shaped element, detaching the first jig element from the base, and then the cup-shaped element being assembled with the base, the second thread column of the cup-shaped element being locked to the second thread hole of the base, the through hole of the cup-shaped element being corresponding to the perforation of the assembling portion of the base.
